(19) United States
(12) Patent Application Publication
(10) Pub. No.: US 2006/0136487 A1
(43) Pub. Date: Jun. 22, 2006

(54) Clustering apparatus and method for content delivery system by content classification

(76) Inventors: Jin Mee Kim, Daejeon (KR); Seung Jo Bae, Daejeon (KR); Sang Min Woo, Daegu (KR); Yuhyeon Bak, Daejeon (KR); Hag Young Kim, Daejeon (KR); Myung Joon Kim, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/300,968

(22) Filed: Dec. 15, 2005

(30) Foreign Application Priority Data
Dec. 22, 2004 (KR) 2004-110745

(51) Int. Cl. G06F 17/00

(52) U.S. Cl. 707/102

(57) ABSTRACT

A clustering apparatus and method for content delivery system are provided. The clustering apparatus includes: a local server for performing operations as a dedicated server providing a stream service by being connected to a cluster; and a file management server for storing original contents.

### BACKGROUND OF THE INVENTION

1. Field of the Invention

The present invention relates to a clustering apparatus and method for a content delivery system, and more particularly, to a clustering apparatus and method for a content delivery system for classifying contents into raw contents not to manage, original contents to manage and copied contents to service and hierarchically transmitting each of classified contents to provide services.

2. Description of the Related Art

Generally, a clustering system installs original contents from each content provider and manages stream services at the same time through a same node while the clustering system provides services. Therefore, it is very difficult to guarantee quality of service (QoS). Also, it is difficult to manage the original contents and copied contents and to recover the original contents or the copied contents from being damaged. Since a stream service dedicated node and a file server node are not distinguished in the clustering system, it cannot continuously provide services when the contents are damaged.

In particular, a central management scheme should be used to manage operations for transmitting contents since consistency is very important for the operations of transmitting contents differently from operation characteristics of the general clustering system.

There were server related conventional technologies introduced in Korean Patent Application No. 2003-11408 entitled “METHOD OF EFFECTIVE CONTENT DISTRIBUTION IN THE CONTENT DELIVERY NETWORK”, Korean Patent Application No. 2001-60791 entitled “METHOD AND APPARATUS FOR CONTENT ROUTING OF CONTENT LEVEL IN THE CONTENT DELIVERY NETWORK”, and Korean Patent No. 149211 entitled “MULTIMEDIA DISTRIBUTION OVER WIDE AREA NETWORK”.

In the first conventional technology introduced in the Korean Patent Application No. 2003-11408, a content provider stores raw content and the stored raw contents include distributed contents. The first conventional technology relates to a method of effectively distributing contents in a content delivering network including a plurality of edge servers installed near to a user side. That is, the conventional method includes a preprocessing step for storing contents in a temporally storage space, a main processing step for distributing the contents stored in the temporally storage space to corresponding edge servers; and an after-processing step for performing a content integrity process. Through such processing steps, the conventional method effectively distributes contents while providing improved reliability.

The second conventional technology introduced in the Korean Patent Application No. 2001-60791 relates to a content level routing of contents requested by a user in CDN environment of the Internet. The second conventional technology provides contents to a user by selecting the optimal edge server according to whether corresponding contents are stored in an edge server, availability of edge server, load of the edge server and distance between the user and the edge server. The second conventional technology has advantages as follows. At first, the data traffic of Internet back-born can be reduced and thus, investment also can be reduced. Also, delay between the user and the edge server is minimized because the optimal edge server is selected and used. Furthermore, more subscribers can be participated because of the reliability Internet is provided. Moreover, new services can be provided by providing wide-bandwidth of streaming according to the second conventional technology.

The third conventional technology introduced in the Korea Patent No. 149211 allows video files to be immediately transmitted through a local area network by transmitting the video file to a local cache using a shared vide file library and a wide area network. The third conventional technology includes: a shared video file library for storing a plurality of video files; a full motion video file cache; a local area network having a unit of transmitting video files to a plurality of viewing stations, where the local area network transmits the video files to the stations in a real time playback rate; a wide are network for accessing the shared video file library, transmits the video files to the local area network at a rate slower than the real time play back rate; a determining unit for receiving a request from the viewing station to view the video files in the local area network and determining whether the requested file is in the cache or not; a first activating unit for activating to transmit the request files through the wide area network from the shared video file library to the cache in response to the determining unit; and a second activating unit for activating to transmit the video files stored in the cache to the viewing stations in a real time playback rate.

Although the conventional technologies have various advantages, the conventional technologies do not disclose a method of effectively managing operations for original content installation and transmitting contents by separately providing a file server node for storing and managing original contents for content classification and dedicated stream service nodes for providing the stream services with the QoS, classifying the contents to separately transmit the classified contents through the file server node and the dedicated stream service node.

### SUMMARY OF THE INVENTION

Accordingly, the present invention is directed to a clustering apparatus and method for a content delivery system, which substantially obviates one or more problems due to limitations and disadvantages of the related art.

It is an object of the present invention to provide a clustering apparatus and method for a content delivery system for classifying contents into raw contents not to manage, original contents to manage and copied contents to service and hierarchically transmitting each of classified contents to provide services.

It is another object of the present invention to provide a clustering apparatus and method for centrally managing operations of all nodes in a cluster by clustering transmitting nodes between the original content and the duplicated contents and for transmitting duplicated contents to a service providing node by configuring original contents in order to provide the real stream services.

It is further other object of the present invention to provide a clustering apparatus and method for allowing different stream service providers to configure proper content service servers in a CDN network that rapidly provides services to numerous subscribers and to centrally manage operations of transmitting contents by clustering service providing nodes and file server nodes having the original contents.

It is yet other object of the present invention to provide a clustering apparatus and method for distinguishing a dedicated node for stream service and a file server node to easily recover contents when the contents are damaged and to improve the usability of the dedicated node and the file server node.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a clustering apparatus of a content delivery system by contents classification including: a local server for performing operations as a dedicated server providing a stream service by being connected to a cluster, and a file management server for storing original contents.

In another aspect of the present invention, there is provided a clustering apparatus of a content delivery system including: a plurality of cluster systems; and a wide area server for distributing target contents to the cluster systems by connecting the cluster systems.

In a further another aspect of the present invention, there is provided a clustering method of a content delivery system including the steps of: a) determining whether a system configuration is properly clustered according to a table when a management request is received from a manager; b) configuring a system information table by receiving system information from a manager when a system is required to be re-configured; c) checking whether the management request is a content installation request when a system is completely configured; d) performing a content installation operation when the management request is the content installation request; e) determining whether the management request is a content transmitting request when the management request is not the content installation request; and f) transmitting contents when the management request is the content transmitting request.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 is a block diagram illustrating a clustering apparatus in a content delivery system by contents classification according to an embodiment of the present invention;

FIG. 2 is a detailed diagram of FIG. 1;

FIG. 3 shows a structure of a system information table in FIG. 2;

FIGS. 4A through 4D are flowcharts showing a clustering method of a content delivery system by contents classification according to an embodiment of the present invention; and

FIG. 5 is a block diagram illustrating a clustering apparatus in a CDN system according to another embodiment of the present invention.

### DETAILED DESCRIPTION OF THE INVENTION

Reference will now be made in detail to the preferred embodiments of the present invention, examples of which are illustrated in the accompanying drawings.

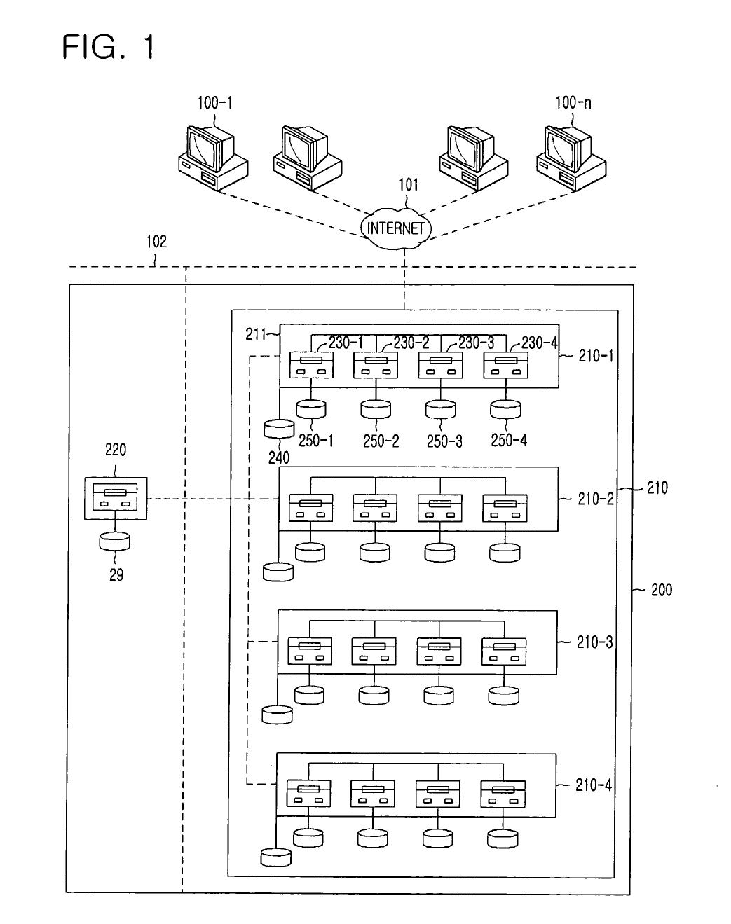

FIG. 1 is a block diagram illustrating a clustering apparatus in a content delivery system by contents classification according to an embodiment of the present invention.

As shown in FIG. 1, the clustering apparatus according to the present embodiment includes a plurality of clients 100-1 to 100-N connected through the Internet 101 and a cluster system 200.

The cluster system 200 includes a local server 210 that is a dedicated server for providing a stream service and a file managing server 220 for storing original contents.

The local server 210 includes a dispatcher node 211 and service providing nodes 210-1 to 2104. The dispatcher node 211 controls to access through virtual addresses so that a cluster system 200 centrally manages a content transmitting operation for a sequence of operations from a manger. The service providing nodes 210-1 to 210-4 performs operations as a transmitting clients that is a file transmission protocol and a transmitting server for content transmitting operations of cluster system in the dispatcher node 211.

The dispatcher node 211 includes a scheduling and load distributor for providing stream services. The dispatcher node 211 manages a local duplicated content table. Also, the dispatcher node 211 manages the service providing nodes 210-1 to 210-4 having a VOD stream service providing server and the file server node 220.

The service providing nodes 210-1 to 210-4 performs a VOD stream service by a plurality of sub-nodes where the dispatcher node 211 decides a sub-node to be transmitted and decided a real content transmission and distribution through a communicating device and a storing device using a file transmission protocol of a service providing node. Also, the service providing node 210-1 to 210-4 receive convents from the file server node 220 and stores duplicated contents.

As described above, each of the service providing nodes 210-1 to 210-4 includes: a plurality of sub-nodes 230-1 to 230-4 achieving a real content transmission and distribution through a communicating device and a storing device included in the sub-node based on a file transmission protocol (FTP) of a service providing node; a main storing unit for storing resource monitoring information, cluster system information and operation information in a transmitting operation managing object of the dispatcher node 211; and a plurality of storing units 250-1 to 250-4 for storing contents for real stream service, which are included in the plurality of sub-nodes 230-1 to 230-4, respectively

The file server node 220 creates original contents, manages original content table and transmits the original contents to the service providing nodes 210-1 to 210-4.

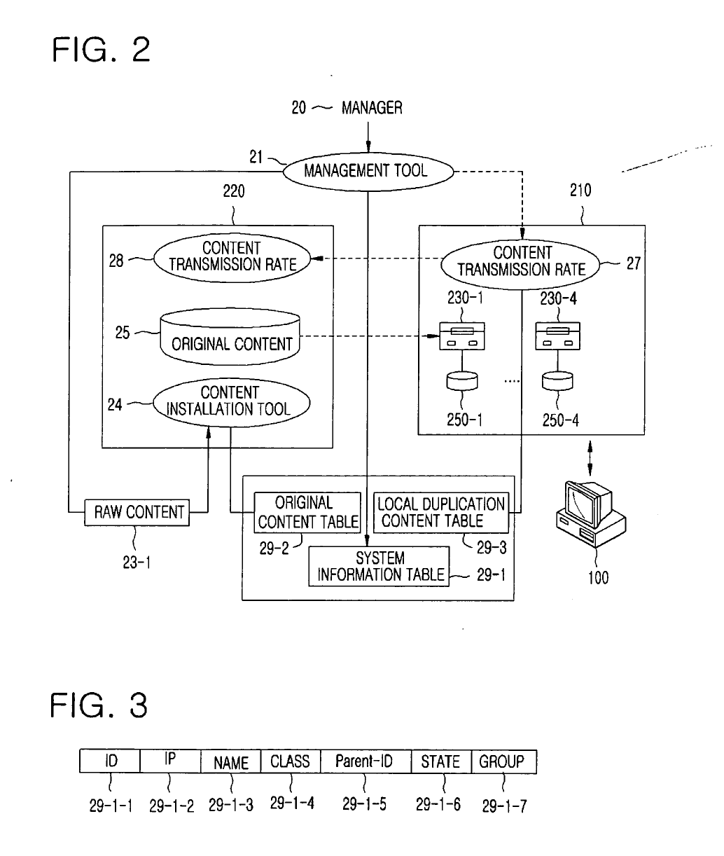

FIG. 2 is a block diagram of the file server node 220 and the local server 210 shown in FIG. 1.

As shown in FIG. 2, the file managing server 220 includes a database server 29 for storing content information managed when installing and transmitting the contents.

The database server 29 also includes a system information table 29-1 for storing information for managing a system to classify functions and states of each node and to install and transmit the contents; an original content table for storing metadata information for original contents installed in the file server node 220 through a content installation tool 24, where the metadata information includes characteristics of contents, i.e., a bit rate of contents, a total running time, a size of contents, and paths to a location of stored contents; and a local duplicated content table 29-3 for storing metadata information and a storing location about the duplicated contents stored in the service providing nodes.

The contents may be classified into raw contents, original contents and duplicated contents. The raw contents are not installed at the file server node 220 through the content installation tool 24. The original contents are installed at the file server node 220 through the content installation tool 24 and include metadata and supplementary files. The original contents are allowed to be deleted by a manager 20. The duplicated contents are transmitted from the file server node 220 through a file transmission function of the dispatcher node 211 and stored in sub-nodes of the service providing nodes. The duplicated contents are allowed to be duplicated to other sub-nodes although the duplicated contents are already stored in a sub-node.

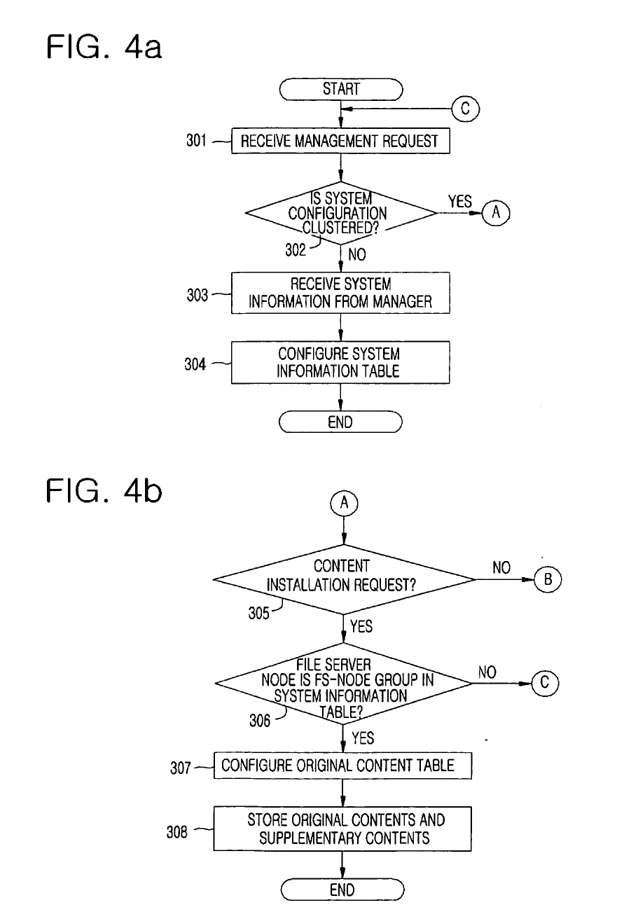

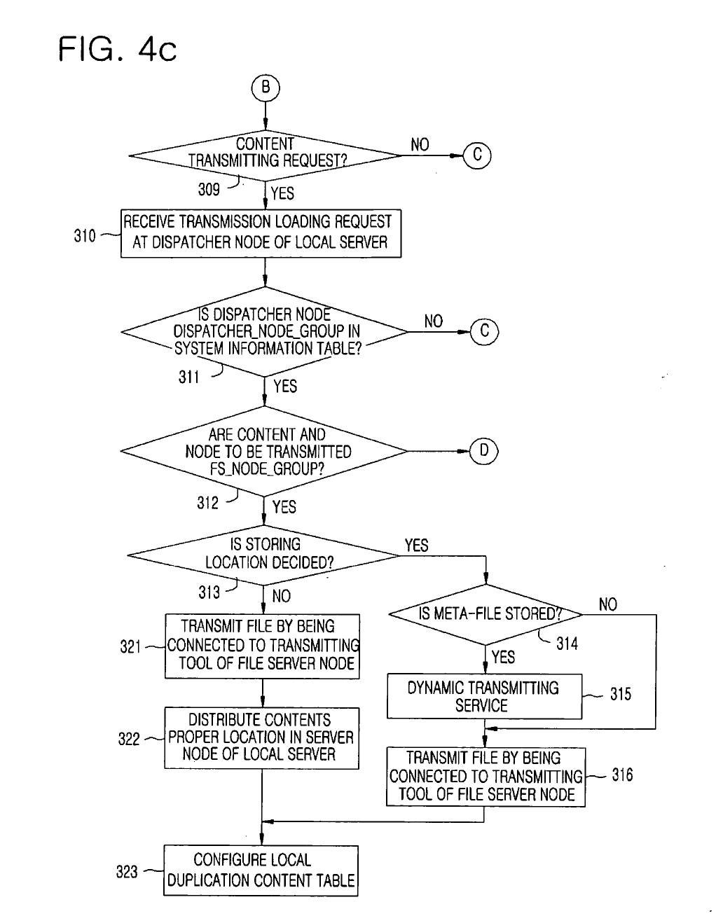

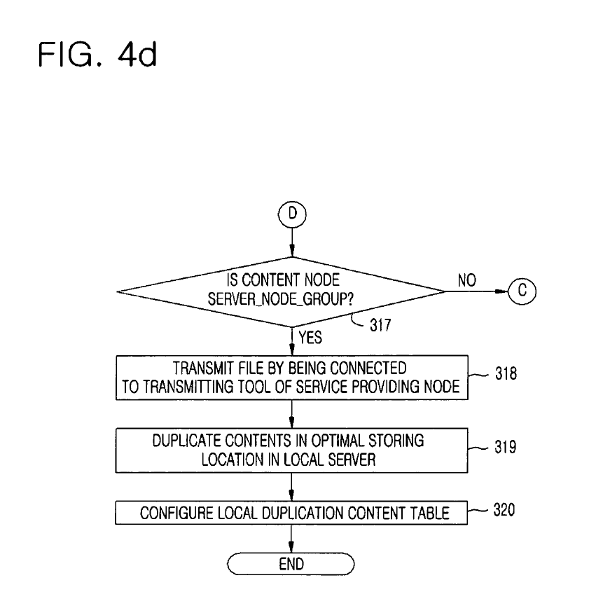

Hereinafter, operations of the clustering apparatus according to the present embodiment will be described with reference to FIGS. 3, 4A through 4D.

At first, a plurality of clients 100-1 to 100-N accesses the cluster system 200 through the Internet 100 and receives stream services, i.e., VOD, by being connected to each of the service providing nodes 210-1 to 210-4 in the cluster system in response to the control of the manger 20.

The cluster system 200 manages operations of transmitting the contents in order to provide the stream services to the clients 100-1 to 100-N through the Internet 101.

The dispatcher node 211 receives requests of stream services from the plurality of clients 100-1 to 100-N. The dispatcher node 211 receives a content transmitting request from the manager 20 and configures a cluster system using a management object for managing the content transmitting operations. That is, the dispatcher node 211 is a representative node of the cluster system 200 including the local server 210 and the file server node 220. The dispatcher node 211 manages operations for clients requesting a plurality of stream services and for clients requesting to manage content transmission requests.

In case of the clients requesting the stream services, the dispatcher node 211 selects nodes among the service providing nodes 210-1 to 210-4 in the cluster system and connects the client to the selected nodes. In case of the clients requesting to manage the contents transmission requests, the dispatcher node 211 selects sub-nodes in the service providing nodes 210-1 to 210-4 and controls the selected sub-nodes to transmit the requested contents through a content transmitting operation embodying apparatus service. The contents are transmitted from the file server node 220 to the local server 210 in the cluster system 220.

The service providing nodes 210-1 to 210-4 have an operating system to manage each of the service providing nodes 210-1 to 210-4 as an independent server. Such the service providing nodes 210-1 to 210-4 provide a real stream service and a file transmission protocol (FTP) service to the clients requesting the stream service and other clients requesting to manage the content transmitting operation requests.

The sub-nodes 230-1 to 230-4 included in each of the service providing nodes are nodes having a communicating device transmitting the contents to perform the real stream service and the file transmitting protocol (FTP) service. The sub-nodes 230-1 to 230-4 transmit or receive the contents stored in the storing device using the communicating device.

The clustering apparatus according to the present invention centrally manages each cluster using the dispatcher node 211 in each cluster system 200.

That is, a system configuration step, a content installation step and a content transmission step are performed in response to requests of the manager 20.

In the system configuration step, cluster system information is stored in the system information table 29-1 in a node of a cluster system having the database server 29, i.e., a mysql server. As shown in Table 1, the cluster system information is stored in the system information table 29-1, classified and operated. In Table 1, the cluster system information of a cluster system configured of a dispatcher node, a service providing node 2 and a file server node 1 is shown as an example of the system information table. However, the present invention is not limited thereby.

TABLE 1

| ID | IP | NAME | CLASS | Parent-ID | STATE | GROUP |
|---|---|---|---|---|---|---|
| Clu.etri.re.kr | 129.254.176.60 | Clu | system | Clu.etri.re.kr | active | LOCAL_VIP |
| v1.etri.re.kr | 129.254.176.69 | v1 | node | Clu.etri.re.kr | active | DISPATCHER_NODE |
| NS0 | 129.254.176.100 | v1/NS0 | NS | v1.etri.re.kr | active | /ns0 |
| NS1 | 129.254.176.101 | v1/NS1 | NS | v1.etri.re.kr | active | /ns1 |
| NS2 | 129.254.176.102 | v1/NS2 | NS | v1.etri.re.kr | active | /ns2 |
| NS3 | 129.254.176.103 | v1/NS3 | NS | v1.etri.re.kr | active | /ns3 |
| v2.etri.re.kr | 129.254.176.70 | v2 | node | Clu.etri.re.kr | active | SERVER_NODE |
| NS0 | 129.254.176.104 | v2/NS0 | NS | v2.etri.re.kr | active | /ns0 |
| NS1 | 129.254.176.105 | v2/NS1 | NS | v2.etri.re.kr | active | /ns1 |
| NS2 | 129.254.176.106 | v2/NS2 | NS | v2.etri.re.kr | active | /ns2 |
| NS3 | 129.254.176.107 | v2/NS3 | NS | v2.etri.re.kr | active | /ns3 |
| fs.etri.re.kr | 129.254.203.166 | fs | node | Clu.etri.re.kr | active | FS_NODE |

FIG. 3 shows a structure of a system information table in FIG. 2.

As shown in FIG. 3, an ID field 29-1-1 and an IP field 29-1-2 are a delimiter for managing a table. The ID field 29-1-1 includes a virtual host name of a cluster system, a name of a service providing node, names of sub-nodes in the service providing nodes such as NS0, NS1, NS2 or NS3, and a name of a file server node. The IP field 29-1-2 includes a virtual address for the virtual host in the cluster system or includes a real address for other nodes. A NAME field 29-1-3 denotes a name of each host. A CLASS field 29-1-4 includes a value for distinguishing node. For example, the CLASS field 29-1-4 has ‘system’ for the cluster system, ‘node’ for a service providing node or a file server node or ‘NS’ for sub-nodes. A STATE field 29-1-6 denotes a state. A GROUP field 29-1-7 has ‘LOCAL-VIP’ for a virtual system of a cluster system, and has ‘DISPATCHER_NODE’ for a service providing node performing operations of a dispatcher. Physically, a node classified into the ‘LOCAL-VIP’ is a node identical to ‘DISPATCHER_NODE’. Such a classification is provided to fault tolerant when the dispatcher node is fail. Accordingly, a client can continuously receive services through the virtual IP ‘LOCAL_VIP’. The GROUP field 29-1-7 has ‘FS_NODE’ for a file server node.

In the content installation step, the original content 25 is configured to provide stream services of the raw contents 23-1 using the content installation tool 24. The original content 25 is installed at the file server node, and metadata information of the original content 25 and a storing path of the original content 25 are stored in the original content table 29-2. The metadata information includes information about characteristics of the original content such as a bit rate, a total running time and a size of content file.

In the content transmitting step, a request of the manager 20 is transmitted to a main content transmitting tool 27 in a dispatcher 211 of a local server 210. The main content transmitting tool 27 analyzes the system information table 29-1 in order to determine whether the corresponding content is duplicated or a duplicated contents stored in other node is copied in the own node. In case of transmitting the original content of the file server node 220 according to the result of determination, the real contents are transmitted using the content transmitting tool 28 in the file server node 220 with reference to the original content table 29-2 based on the file transmission protocol (FTP). While transmitting the contents, the real contents are stored in a target sub-node of the local server 210 and related information is recorded in the local duplication content table 29-3. In case of copying the duplicated contents stored in other local server 210, the contents are duplicated in other sub-node in the local server with reference to the local duplication content table 29-3 and related information is recorded in the local duplication content table 29-3.

A client receiving a real stream service is connected to the dispatcher node 211 through a virtual IP. When a request for a real stream service is received, corresponding contents are selected with reference to the local duplication content table 29-3 and the client redirects to a service providing node having a real stream server related to the requested steaming service based on a real time streaming protocol (RTSP) that controls a client and stream data. Then, the corresponding service is provided to the client in a cluster A reason of using a dispatcher node in the local server without using a file server node is to process the RTSP in a stream server.

Hereinafter, the system configuring step, the content installation step and the content transmitting step will be described with reference to FIGS. 4A through 4D.

If a management request of the manager 20 is received at step S301, it determines whether a system to be managed is clustered according to a table at step S302. If the system is required to be re-configured, the system information is received from the manager 20 at step S303 and the system information table is configured at step S304.

On the contrary, if the system is already configured at the step S302, it determines whether the management request is a request for installing contents or not at step S305. In case of the content installation request, it determines whether the file server node is set as a file server node group “FS_NODE GROUP” in the system information table at step S306.

If the file server node 220 is properly set, the original content table 29-2 is configured of metadata that is stored when the content is installed at step S307. Then, the real original contents and additional contents are stored at step S308. If the file server node 220 is not properly set in the step S306, new management request will be received.

If the received request at the step S305 is a content transmission request at the step S309, the dispatcher node 211 of the local server 210 in the cluster system 200 receives a request of transmission loading at step S310. Then, it determines whether the dispatcher node 211 is properly set at the system information table 29-1 as ‘DISPATCHER_NODE GROUP’ at step S311, and it determines whether a target node is the file server node ‘FS_NODE GROUP’ or not at step S312.

If the request is to transmit original contents of the file server node 220 at step S312, it determines whether a storing location in a sub-node of a service providing node having the real contents is determined at step S313. If the storing location is determined, it checks whether metafile required for stream service is stored or not and whether meta-information is stored in the local duplication content table 29-3 at step S314.

If the storing location is not determined, files are transmitted through the content transmission tool 28 of the file server node 220 at step S321, the contents are arranged at the storing location of the sub-node in the local server 210 at step S321 and a local duplication table is configured at step S323.

If the files with the meta-information are not stored in the step S314, files are transmitted through the content transmission tool 28 of the file server node 220 at step S316 and meta-information of the received contents is recorded in the local duplication content table 29-3 at step S320.

If the files with the meta-information are stored in the step S314, files are transmitted through a transmission tool of the file server node 220 at step 316 because the received request is to immediately provide a stream service right after receiving the original contents through a dynamic transmission service at step S315. Then, the meta-information of the received contents is recorded in the duplication content table 29-3 at step S320.

If the target node is not the file server node 220 at step S312, it determines whether a location of the contents is in SERVER_NODE GROUP or not at step S317 because it is a case of duplicating the contents in the own sub-node to other sub-node. If the contents is stored in the service providing node without stored in the file server node 220, the files are transmitted the content transmission tool 27 of the service providing node at step S318, the contents are duplicated to an optimal location of the local server 210 at step S319, and the local duplication content table 29-3 is configured at step S320.

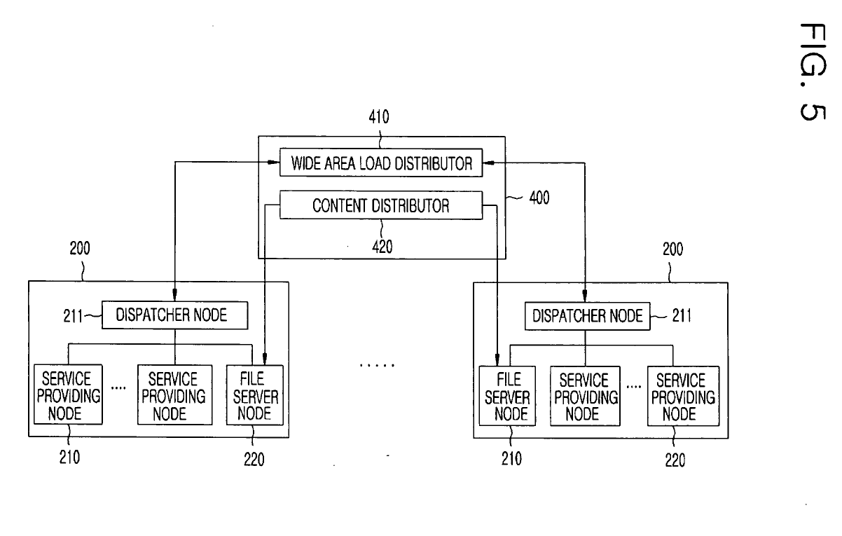

Hereinafter, a clustering apparatus of a CDN system according to another embodiment of the present invention will be described with reference to FIG. 5.

FIG. 5 is a block diagram illustrating a clustering apparatus in a CDN system according to another embodiment of the present invention.

As shown in FIG. 5, the clustering apparatus according to another embodiment includes a plurality of cluster systems 200 and a wide area server 400 for distributing contents to the cluster systems 200.

Each of the cluster systems 200 includes a file management server 220 for storing original contents provided from the wide area server 400; a dispatcher node 211 for centrally controlling a content transmission operation in the cluster system 200 by assigning virtual addresses; and a plurality of service providing nodes 210 for performing operations as a transmitting client or a transmitting server in order to perform the content transmission operation of the cluster system in the dispatcher node 211.

The wide area server 400 includes a wide area load distributor 410 for connecting the cluster systems 200 and a content distributor 420 for providing the original contents to the file server node 220.

Hereinafter, operations of the cluster apparatus of CDN system according to another embodiment will be described.

The wide area server 400 includes the wide area load distributor 410 that connects each edge server providing real services. The edge server in FIG. 4 is an independent cluster system 200 embodied according to the present invention. The real services are provided by a service providing node 210 decided by the dispatcher node 211 in the cluster system 200 decided by the wide area load distributor 410. Each of cluster systems may receives receive target contents as the original content type from the file server node 220 by the content distributor 420 of the wide area serer 400. The original contents may be loaded in the service providing node as a local duplicated content to provide a real stream service. The real stream service may be provided while receiving the contents from the file server node 220 after receiving only related metadata for dynamic transmitting service.

As described above, the clustering apparatus and method for a content delivery system according to the preset invention can provide services by classifying contents into raw contents not to manage, original contents to manage and copied contents to service and hierarchically transmitting each of classified contents.

Also, the clustering apparatus and method according to the present invention can centrally manages operations of all nodes in a cluster by clustering transmitting nodes between he original content and the duplicated contents, and can transmit the duplicated contents to the service providing node by configuring the original contents in order to provide the real stream services.

Furthermore, the clustering apparatus and method according to the present invention can transmit contents after transmitting only metadata to the service providing node while providing services. Therefore, usability of storing devices in the service providing node is improved and various contents services can be provided with only storing the meta-files.

Moreover, different stream service providers can be configured proper content service servers in a CDN network that rapidly provides services to numerous subscribers, and transmitting operations can be centrally managed by clustering the service providing nodes and the file server nodes having the original contents according to the present invention.

Since the dedicated node for stream service and the file server node are distinguished in the present invention, it is easy to recover contents when the contents are damaged, and the usability of the dedicated node and the file server node is improved.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A clustering apparatus of a content delivery system by contents classification comprising:
a local server for performing operations as a dedicated server providing a stream service by being connected to a cluster; and
a file management server for storing original contents.

2. The clustering apparatus of claim 1, wherein the local server includes:
a dispatcher node for controlling cluster system to access through a virtual address so that the cluster system centrally manages operations of transmitting contents for sequence of operations from a manager;
a plurality of service providing nodes for performing operations as a transmitting client that is a file transmission protocol (FTP) and a transmitting server so that the dispatcher node performs content transmitting operations of a cluster system.

3. The clustering apparatus of claim 2, wherein the dispatcher node includes a scheduling and a load distributor for a steam service.

4. The clustering apparatus of claim 2, wherein the dispatcher node manages a local duplication content table, and manages operations by monitoring the service providing nodes including a VOD stream service server and a file server node.

5. The clustering apparatus of claim 2, wherein the service providing node performing a VOD stream service by a plurality of sub-nodes which are selected by the dispatcher node as a destination node of contents and transmit and distribute real contents through a communicating device and a storing device included in the sub-node.

6. The clustering apparatus of claim 2, wherein the service providing node receives contents from the file server node and stores duplicated contents.

7. The clustering apparatus of claim 2, wherein the service providing node includes:
a plurality sub-nodes transmit and distribute real contents through a communication device and a storing device included in the sub-nodes based on a file transmission protocol of the service providing node;
a main storing unit for storing resource monitoring information, cluster system information and operation information in a transmission operation management object of the dispatcher node; and
a plurality of storing units for storing contents for real stream service in a sub-node included in the service providing node.

8. The clustering apparatus of claim 2, wherein the file server node creates and installs original contents, manages an original content table and transmits the original contents to a service providing node.

9. The clustering apparatus of claim 2, wherein the file management service includes a database server for storing content information managed when installing and transmitting contents.

10. The clustering apparatus of claim 9, wherein the database server includes:
a system information table for classifying functions and states of each node, and for installing and transmitting contents;
an original content table for storing meta-data information of original contents installed at a file server node through a content installation tool; and
a local duplication content table for storing a storing location of duplication contents stored in a service providing node through a content transmitting function and meta-data information of the duplication contents.

11. The clustering apparatus of claim 10, wherein the contents includes:
a raw content that is not installed at a file server node through a content installation tool;
an original content installed at a file server node through a content installation tool, including meta-data and supplementary files and deleted by only a manager; and
a duplication content stored at a sub-node of a service providing node performing a real stream service by receiving contents from a file server node through a file transmitting function of a dispatcher node, or stored at a sub-node by copying a content stored in other sub-node.

12. A clustering apparatus of a content delivery system comprising:
a plurality of cluster systems; and
a wide area server for distributing target contents to the cluster systems by connecting the cluster systems.

13. The clustering apparatus of claim 12, wherein the cluster system includes:
a file management server for storing original contents provided from the wide area server;
a dispatcher node for controlling the cluster systems to access through a virtual address so that the cluster system centrally manages operations of transmitting contents; and
a plurality of service providing nodes for performing operations as a transmitting client, that is a file transmission protocol (FTP), and a transmitting server so that the dispatcher performs operations of transmitting contents of cluster system.

14. The clustering apparatus of claim 12, wherein the wide area server includes:
a wide area distributor for connecting a plurality of cluster systems; and
a content distributor for providing original contents to the file server node.

15. A clustering method of a content delivery system comprising the steps of:
a) determining whether a system configuration is properly clustered according to a table when a management request is received from a manager;
b) configuring a system information table by receiving system information from a manager if a system is required to be re-configured at the step a);
c) checking whether the management request is a content installation request if a system is completely configured at the step a);
d) performing a content installation operation if the management request is the content installation request at the step c);
e) determining whether the management request is a content transmitting request if the management request is not the content installation request at the step c); and
i) transmitting contents if the management request is the content transmitting request at the step e).

16. The clustering method of claim 15, wherein the step d) includes the steps of:
d-1) determining whether a file server node in the step d) is a file server node group in a system information table; and
d-2) storing original contents and supplementary contents by configuring an original content table if the file server node is the file server node group in a system information table at the step d-1).

17. The clustering method of claim 1 5, wherein the step f) includes the steps of
f-1) determining whether a dispatcher node is a dispatcher node group in a system information table after a dispatcher node of a local server receives a transmission loading request;
f-2) determining whether a content to be transmitted is a file server node group if the dispatcher node is a dispatcher node group in a system information table at the step f-1);
f-3) determining whether a storing location is decided or not if the content to be transmitted is the file server node group at the step f-2);
f-4) transmitting files by being connected to a transmission tool of a file server node if the storing location is not determined at the step f-3); and
f-5) distributing contents in a proper storing location of a predetermined server node in a local server and configuring a local duplication content table.

18. The clustering method of claim 17, wherein the step f) further includes the steps of:
f-6) determining whether a content node to be transmitted is a server node group if the content to be transmitted is not the file server node group;
f-7) transmitting files by being connected to a transmission tool of a service providing node if the content node to be transmitted is the server node group at the step f-6); and
f-8) copying contents in an optimal storing location in a local server and configuring a local duplication content table.

19. The clustering method of claim 17, wherein the step f) further includes the steps of:
f-9) determining whether meta-file is stored or not if the storing location is decided at the step f-3); and
f-10) transmitting files by being connected to a transmission tool of a file server node through performing a dynamic transmitting service and configuring a local duplication content table if the meta-file is stored at the step f-9).
